(19) United States
(12) Patent Application Publication
(10) Pub. No.: US 2016/0305799 A1
(43) Pub. Date: Oct. 20, 2016

(54) REMOTELY ADAPTED VIRTUAL SENSOR OPTIMIZATION SYSTEM AND METHOD

(71) Applicant: FAZ TECHNOLOGY LIMITED, Dublin (IE)

(72) Inventors: Robin Lewis, Orlando, FL (US); Neil Tomlinson, Orlando, FL (US)

(73) Assignee: FAZ TECHNOLOGY LIMITED, Dublin (IE)

(21) Appl. No.: 14/688,077

(22) Filed: Apr. 16, 2015

(51) Int. Cl. G01D 18/00; G01D 5/26

(52) U.S. Cl. CPC G01D 18/00; G01D 5/26

(57) ABSTRACT

The present invention relates generally to the field of sensors, and, more particularly, to a system and method for remotely virtualizing deployed optical sensors to dynamically upgrade/optimize the deployed sensor's performance and to extend the life of a deployed sensor.

### BACKGROUND OF THE INVENTION

1. Field of the Invention

The present invention relates generally to the field of sensors, and, more particularly, to a system and method for remotely virtualizing deployed optical sensors to dynamically upgrade/optimize the deployed sensor's performance and to extend the life of a deployed sensor.

2. Description of the Related Art

Conventional optical sensor technology is typically manufactured and characterized at a factory, deployed in the field to perform certain functions, and lives out its deployed performance life cycle in a progressively degrading manner until failure. Optical sensors are typically used in harsh environments where electronic sensors do not meet certain demanding conditions. Much of the same sensory information as deployed via electronic sensors is generated by optical sensors without the use of electricity to generate sensory information. A typical optical sensor based system could be an oil transport application where sensors are required to monitor pressure and gas emissions inside oil containment tanks. Optical sensors monitoring for pressure and noxious gas alert conditions can be utilized given their ability to withstand these harsh environmental conditions and operate in without placing electrical current inside the containment tank.

Description of the Related Art Section Disclaimer: To the extent that specific patents/publications/products/systems are discussed above in this Description of the Related Art Section or elsewhere in this Application, these discussions should not be taken as an admission that the discussed patents/publications/products are prior art for patent law purposes. For example, some or all of the discussed patents/publications/products/systems may not be sufficiently early in time, may not reflect subject matter developed early enough in time and/or may not be sufficiently enabling so as to amount to prior art for patent law purposes. To the extent that specific patents/publications/products/systems are discussed above in this Description of the Related Art Section and/or throughout the application, the descriptions/disclosures of which are all hereby incorporated by reference into this document in their respective entirety(ies).

### SUMMARY OF THE INVENTION

The present invention recognizes that there are potential problems and/or disadvantages with the optical sensor technology. First, there does not exist any practical way to optimize a deployed sensor's performance in a deployed condition over an operational life cycle. Second, there is no current technology that creates, propagates, governs, and disseminates optical sensor lifecycle informatics, which can have a variety of uses including optimizing a deployed sensor's performance in a deployed condition (as discussed further below with reference to an embodiment of the present invention). Further, there is no current technology which allows for easy extension of monitoring capabilities to new sensor types or for remote re-appropriation of sensors to solve new problems. Various embodiments of the present invention may be advantageous in that they may solve or reduce one or more of the potential problems and/or disadvantages with conventional deployed optical sensor based systems discussed herein.

Various embodiments of the present invention may exhibit one or more of the following objects, features and/or advantages:

It is therefore a principal object and advantage of the present invention to provide a system and method for remotely virtualizing deployed optical sensors to dynamically upgrade/optimize the deployed sensor's performance (within the sensing environment) and to extend the life of a deployed sensor for an overall reduced maintenance cost. Optimal sensor performance can require that deployed sensors need to dynamically adapt over time in response to learned behavior, observed behavior and user specified application. Learned behavior can relate to how a generic group of sensors are characterized and codified such as via a factory delivery template, measurement formulas, interrogation management, context application and statistical filtering, iodates with new groups and accumulated knowledge updates. Observed behavior can relate to how an individual sensor operates in its deployed environment, and can include performance, noise, accuracy and repeatability. User specified application relates to how an individual sensor can be applied in its unique environment, and can include performance bounds, aggregation, alarms, and degradation order.

It is another object and advantage of the present invention to provide a system and method for remotely virtualizing deployed optical sensors to re-instantiate deployed sensors with upgraded characterization to improve/upgrade performance.

It is further object and advantage of the present invention to provide a system and method for remotely virtualizing deployed optical sensors to re-appropriate virtual sensors in a virtual environment when new sensor aggregations can be reapplied to new application spaces (virtual manipulation of deployed sensors into new application aggregations—maximizing sensor extensibility).

It is another object and advantage of the present invention to provide a system and method for remotely virtualizing deployed optical sensors to allow for the collection and persistence of sensor characterization content and informatics in deployed environments over a deployment life cycle. Such a system and method can be valuable to, among other entities, sensor vendors who want to make their sensor informatics available and extensible to multiple persistence engine technologies without altering their product base.

It is a further object and advantage of the present invention to provide a system and method for remotely virtualizing deployed optical sensors to allow for the dynamic realization of virtual sensor formation over time in cyberspace. The Virtual Sensor Objects (VSO) preferably exist in the “cloud” and are structured, located, connected, and/or programmed to accumulate and assimilate information regarding and/or collected by a deployed sensor (or a plurality of deployed sensors).

In accordance with the foregoing objects and advantages, an embodiment of the present invention is directed to a method for remotely virtualizing deployed optical sensors. The method can define a series of steps that result in the formation of a Virtual Sensor Object (VSO), and using the VSO to optimize performance of a deployed sensor. The method can generally employ, but is not limited to, the steps of characterizing baseline generic sensor behavior; forming/creating a VSO; associating the VSO with at least one deployed optical sensor (and possibly a group of deployed sensors); adapting the deployed sensor based on user specification; adapting the deployed sensor based on analytical observation; and using prognostics to evaluate end of life of the sensor and condition the system for sensor retirement. The VSO can be instantiated with base performance characteristics and user defined application which can reflect an initial deployed state. During the lifecycle process, the VSO can propagate to observed measurement and can be tested for performance and prognostics evaluation which result in potential re-provisioning of deployed sensor objects to extend performance life. Out of spec sensors can be retired within the deployed sensing environments.

The method for remotely virtualizing deployed optical sensors of an embodiment of the present invention is a novel approach for creating, persisting and marshalling a deployed optical sensor through its optimal performance life cycle. The non-trivial methods steps, as detailed herein and below, dynamically optimize performance and extend sensor life and are uniquely adapted to specific user application. Optimization can be realized via a combination of iterative sensor formation sequences. In accordance with an embodiment with the present invention, sensor objects can be adaptive to continuous analytical observation, user specification and remotely available characteristic templating, for example. End of life accommodation can ensure non performing sensors are retired and accounted for within the sensing enterprise.

In accordance with the foregoing objects and advantages, an embodiment of the present invention is also directed to a system and components thereof for remotely virtualizing deployed optical sensors. The system can include, but is not limited to, components, modules, and/or a non-transitory computer-readable storage mediums containing program code structured, located, connected and/or programmed to implement the methodology discussed herein.

The transmission/transfer of data, control signals and/or monitoring signals from various portions/components of embodiments of the system described herein can be via wireless communication/transmission over a network, which can be any suitable wired or wireless network capable of transmitting communication, including but not limited to a telephone network, Internet, Intranet, local area network, Ethernet, online communication, offline communications, wireless communications and/or similar communications means. The wireless transmission can be accomplished through any wireless protocol/technology, including, but not limited to, ZigBee standards-based protocol, Bluetooth technology, and/or Wi-Fi technology. Further, this data can be encrypted as needed based on the sensitivity of the data or the location the components of the system, for example. Components of the system can be located in the same room, in a different room in the same building, in a completely different building and location from one another.

In accordance with a preferred embodiment of the present invention, a specialized improved computer system is created—here the devices and/or systems that are specifically structured, configured, connected, and/or programmed to create a VSO, and associate the VSO with at least one deployed optical sensor to remotely and virtually optimize and extend the performance life cycle of an optical sensor.

### BRIEF DESCRIPTION OF THE DRAWINGS

The present invention will be more fully understood and appreciated by reading the following Detailed Description in conjunction with the accompanying drawings, in which:

FIG. 1 is a flow diagram representation of an embodiment of the method according to the present invention.

FIG. 2 is a system architecture diagram in combination with flow diagram elements showing certain functionality of the system and steps of a method in accordance with an embodiment of the present invention.

### DETAILED DESCRIPTION

The present invention will be more fully understood and appreciated by reading the following Detailed Description in conjunction with the accompanying drawings, wherein like reference numerals refer to like components.

As detailed herein, a novel methodology for Virtual Sensor Object (VSO) abstraction and deployed sensor life cycle performance optimization is provided. An embodiment of the present invention describes a virtual sensor's creation and associative interaction with its learned and observed behaviors (based on the deployed sensor), as well as, user conditioning in order to maximize performance over the deployed sensor's life cycle. In accordance with an embodiment of the present invention, deployed physical sensors can form a persistent set of life-cycled VSOs, which can be in enterprise level virtual space. Every fielded physical sensor can result in the creation and propagation of its own unique VSO. The VSOs can evolve over time, contain all the important aspects related to each sensor, and associate all the important informatics for and related to health and performance characterization. Each VSO can be remotely addressable via URL for preferably non-disruptive continued characterization, evaluation and re-appropriation. In addition to supplying sensor informatics/measurements to the user, VSO(s) can also be manipulated, evaluated, and re-appropriated in virtual space to aggregate and test new sensor array applications and analytic interactions before provisioning updates to deployed systems. VSO structure can include, but is not limited to, a header (Sensor ID, time stamp, age, System ID, Interrogator ID, Fiber ID, location on fiber, deployed geo-location); measurement (template ID, current value, high/low value, mean value, User specified performance metric, current performance metric, information persistence mode, deployed aggregation) and health (estimated end of life, observed failure mode, observed failure mode count, life cycle state).

In accordance with an embodiment of the present invention, the system and method for virtualizing deployed sensors as described and illustrated herein can be applicable to optical sensors and to electrical sensors. Sensor system updates can be evaluated to address random and systematic errors, and then measurement formulas, sensor aggregations, interrogations controls, statistical filtering and new analytics can be redeployed to deployed systems to improve performance and extend sensor life.

As shown in the Figures and as set forth in the descriptions of the Figures below, an embodiment of the present invention sets forth a methodology (i) that virtualizes physical sensors and applies templates, user conditioning, continuous observation and analytics to dynamically optimize performance over a physical sensor's lifecycle; (ii) that marshals a physical sensor through a sequence of formation states that propagate a complete set of sensing informatics; (iii) by which new sensor characteristics are captured syntactically and semantically within a dynamically loaded template that is dynamically instantiated within a deployed sensing enterprise; and (iv) allows URL addressable VSO re-appropriation into virtual aggregation environments and dynamically associates related analytics and applications.

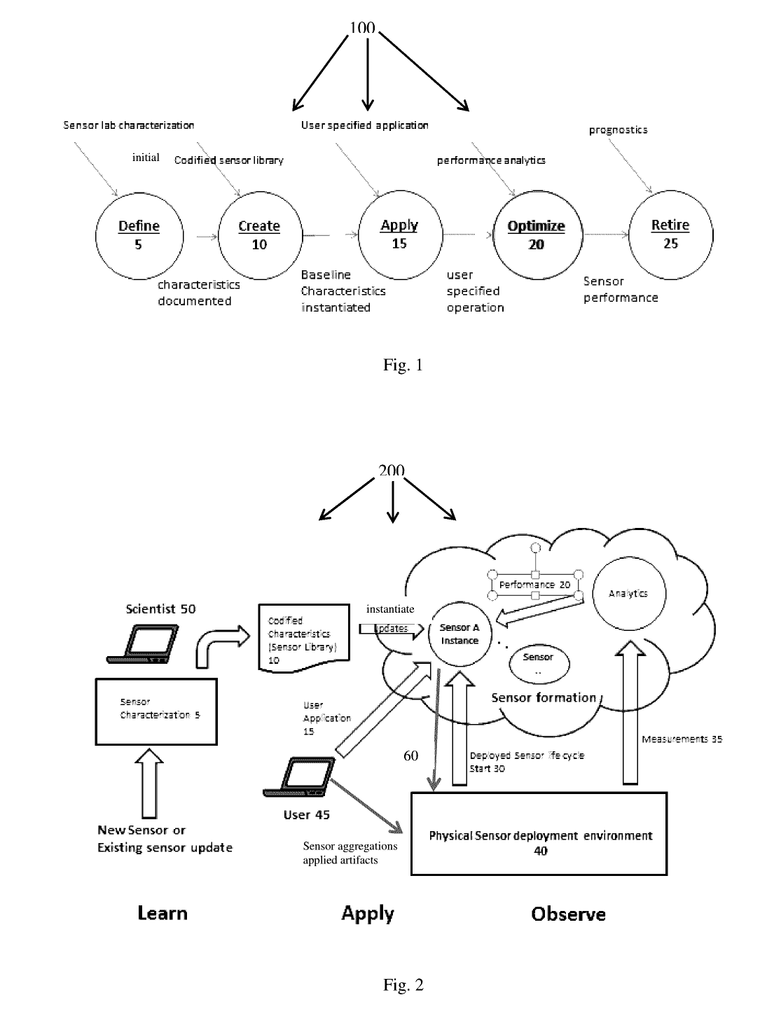

Turning to FIG. 1, a flow diagram representation of an embodiment of the method 100 according to the present invention, which can include, but are not limited to, the enumerated steps. These steps describe and/or illustrate the formation of a VSO, the use of a VSO to optimize the performance of a deployed sensor, and the deployed sensor's life cycle. Beginning at step 5, baseline generic sensor behavior is characterized offline and documented. Characteristics can include, but are not limited to, measurement formulization, sensor measurement coefficients, and interrogation processing for determination of wavelength center. Step 10 takes the documented sensor characteristics and codifies the measurement formulization, measurement coefficients and wavelength center interrogation algorithm in the supported sensor library. Upon completion of steps 5 and 10 a generic sensor library prescription for supported physical sensors is available for VSO application provisioning.

The next set of steps describe the formation and maintenance of VSOs via mining of data relative to observed sensor performance in order to recalibrate a deployed sensor to optimize the sensor thought its lifetime. i.e., virtually maintaining sensors based on the obtained info. The life of the sensors can be optimized by mining the physical sensor data (evaluation of the return waveform), and applying a physical change (change the waveform interrogation processing based on observation of the waveform data) or a nonphysical change (application of statistical filtering to clean up the sensor data and re-application of measurement coefficients and measurement formulization).

In particular, steps 10, 15 and 20 show the formation/creation of a VSO based on, for example, a unique sequence of iterative sensor abstraction state steps including a provisioned or codified sensor library objects application step (step 10), a user conditioned application step (step 15) and a performance analytics application step (step 20). The formed/created VSO or abstracted aggregation of VSOs is associated with a particular deployed optical sensor or aggregation of optical sensors. Step 10 creates the VSO for a physically deployed sensor by provisioning the codified sensor library. Created VSOs can exist either within the deployed physical environment's database or in a remote cloud architecture. Once they are created they individually are marshaled through their lifecycle as prescribed in steps 15, 20 and 25. New VSO creation can also potentially retire existing VSOs if new sensor library component updates are required to optimize operational VSOs independent of dynamically observed sensor performance. Steps 15 and 20 show how the deployed sensor can be adapted based on a user specified application (step 15), and analytical observation/performance analytics (step 20). At Step 15, a deployed sensor's performance requirements, user alert mechanization, and system context are dynamically applied based on user specification. A user can specify a deployed sensor's context application for aggregation and geolocation. Upon completion of step 15 a VSO is fully conditioned with user specified application as can be required within the deployed system context.

At step 20, performance analytics can now be used to (i) task and control interrogation operation to accommodate degrading physical sensor performance across optical sensor families, (ii) characterize deployed sensor performance, and (iii) aid in sensor optimization via filtering measurement noise to maximize accuracy and repeatability in deployed sensor environments. In essence, deployed sensors can be periodically or continuously evaluated autonomously via analytics to characterize deployed sensor performance, and to create opportunity for sensor optimization via filtering measurement noise to maximize accuracy and repeatability in deployed sensor environments. (i) Task and control of interrogation operation involves dynamically monitoring and controlling the optical sensor waveform characteristics. This can be performed virtually if the system bandwidth allows for interaction at the required rate, otherwise it must be executed within the interrogation component of the deployed system. Monitor and control can be, but not limited to, observation of the center frequency magnitude over time for degradation and reapplication of signal gain, and re-appropriation of transmitted laser frequency energy to specific regions and frequencies. (ii) Characterization of deployed sensor performance is applied to VSOs via dynamic construction of a performance metric and its subsequent evaluation against user specified performance requirements. The VSO performance metric is calculated by, but not limited to, statistical VSO measurement observation over time relative to similar system VSO application, consistency of the VSO measurement, and interrogation processing status. (iii) Aid in sensor optimization via filtering measurement noise is the step 20 sub-component used to statistically affect VSO measurement quality. This can be accomplished by, but not limited to, application of statistical averaging and filtering. At step 25, prognostics are used to evaluate end of life of the sensor and condition the system for sensor retirement. End of life accommodation can ensure non-performing sensors are retired and accounted for within the sensing enterprise.

FIG. 2 is a system architecture diagram in combination with flow diagram elements showing certain functionality of the system and steps of a method in accordance with an embodiment of the present invention. FIG. 2 relates to a VSO abstraction/formation. A deployed sensor (Sensor A) is shown being deployed at 30 in a physical sensor deployment environment 40. The steps as described with respect to FIG. 1 are shown being implemented in FIG. 2 with respect to Sensor A. At step 5, sensor characterization is performed with respect to existing Sensor A. The codified sensor library objects application step (step 10), user conditioned application step (step 15) and performance analytics application step (step 20) are also shown. Arrow 60 represents measurement formulas, and interrogation management statistical filtering.

A “module,” as may be used herein, can include, among other things, the identification of specific functionality represented by specific computer software code of a software program that is recorded on a computer readable medium. A software program may contain code representing one or more modules, and the code representing a particular module can be represented by consecutive or non-consecutive lines of code. The computer-executable program instructions of an embodiment of the present invention can comprise any computer-programming language known in the art, including but not limited to C, Java, Python, Perl, ActionScript and JavaScript, among many others.

As will be appreciated by one skilled in the art, aspects of the present invention may be embodied/implemented as a computer system, method or computer program product. The computer program product can have a computer processor or neural network, for example, which carries out the instructions of a computer program. Accordingly, aspects of the present invention may take the form of an entirely hardware embodiment, an entirely software embodiment, and entirely firmware embodiment, or an embodiment combining software/firmware and hardware aspects that may all generally be referred to herein as a “circuit,” “module,” “system,” or an “engine.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, completely or partly on the thermal printer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flow diagrams/charts/block diagrams/system architecture diagrams in the Figures illustrate the architecture, functionality, and operation of possible implementations of systems, methods, and computer program products according to various embodiments of the present invention. In this regard, each block in the flowcharts/block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While several embodiments of the invention have been discussed, it will be appreciated by those skilled in the art that various modifications and variations of the present invention are possible. Such modifications do not depart from the spirit and scope of the present invention.

What is claimed is:

1. A method of remotely virtualizing deployed optical sensors comprising the steps of:
forming a virtual sensor object;
associating the virtual sensor object with a deployed physical optical sensor;
receiving user specified input data;
collecting performance input data from the deployed physical optical sensor; and
adapting the deployed physical optical sensor, via the virtual sensor object, based on the performance input data or the user specified input data.

2. The method of claim 1, further comprising the step of characterizing baseline generic optical sensor behavior.

3. The method of claim 2, wherein the step of characterizing further comprises the step of documenting baseline generic optical sensor behavior characteristics selected from the group consisting of measurement formulization, sensor measurement coefficients, and interrogation processing for determination of wavelength center.

4. The method of claim 3, further comprising the step of codifying the documented baseline generic optical sensor behavior characteristics in a baseline generic optical sensor library.

5. The method of claim 4, wherein the step of forming a virtual sensor object further comprises the step of provisioning the codified baseline generic optical sensor library.

6. The method of claim 1, wherein the user specified input data is selected from the group consisting of the deployed physical optical sensor's performance metric requirements, the deployed physical optical sensor's identification, user alert mechanization, and the deployed physical optical sensor's geolocation and application context.

7. The method of claim 1, wherein the step of collecting further comprises the step of collecting waveform characteristic data of the deployed physical optical sensor.

8. The method of claim 1, wherein the step of adapting further comprises the step of applying a physical change.

9. The method of claim 8, wherein the step of applying a physical change further comprises the steps of changing waveform interrogation processing of the deployed physical optical sensor, reapplying signal gain of the deployed physical optical sensor, or re-appropriating transmitted laser frequency energy to specific regions and frequencies.

10. The method of claim 1, wherein the step of adapting further comprises the step of applying a non-physical change comprising filtering measurement noise.

11. The method of claim 1, further comprising the steps of
characterizing the collected performance input data from the deployed physical optical sensor;
comparing the characterized performance input data with the received user specified input data; and
adapting the deployed physical optical sensor, via the virtual sensor object, based on the step of comparing wherein when the step of comparing indicates that the characterized performance input data is outside of a predetermined value.

12. A non-transitory computer-readable storage medium containing program code comprising:
program code for forming a virtual sensor object;
program code for associating the virtual sensor object with a deployed physical optical sensor;
program code for receiving user specified input data;
program code for collecting performance input data from the deployed physical optical sensor; and
program code for adapting the deployed physical optical sensor, via the virtual sensor object, based on the performance input data or the user specified input data.

13. The non-transitory computer readable storage medium of claim 12, further comprising program code for characterizing baseline generic optical sensor behavior.

14. The non-transitory computer readable storage medium of claim 13, further comprising program code for documenting baseline generic optical sensor behavior characteristics selected from the group consisting of measurement formulization, sensor measurement coefficients, and interrogation processing for determination of wavelength center.

15. The non-transitory computer readable storage medium of claim 14, further comprising program code for codifying the documented baseline generic optical sensor behavior characteristics in a baseline generic optical sensor library.

16. The non-transitory computer readable storage medium of claim 15, further comprising program code for forming a virtual sensor object further comprises the step of provisioning the codified baseline generic optical sensor library.

17. The non-transitory computer readable storage medium of claim 12, wherein the program code for adapting further comprises program code for applying a physical change.

18. The non-transitory computer readable storage medium of claim 17, wherein the program code for further comprises program code for changing waveform interrogation processing of the deployed physical optical sensor, reapplying signal gain of the deployed physical optical sensor, or re-appropriating transmitted laser frequency energy to specific regions and frequencies.

19. The non-transitory computer readable storage medium of claim 12, wherein the program code for adapting further comprises program code for applying a non-physical change comprising filtering measurement noise.

20. The non-transitory computer readable storage medium of claim 12, wherein the program code for:
characterizing the collected performance input data from the deployed physical optical sensor;
comparing the characterized performance input data with the received user specified input data; and
adapting the deployed physical optical sensor, via the virtual sensor object, based on the step of comparing wherein when the step of comparing indicates that the characterized performance input data is outside of a predetermined value.
